(19) United States
(12) Patent Application Publication
(10) Pub. No.: US 2006/0253243 A1
(43) Pub. Date: Nov. 9, 2006

(54) System and method for tire/road friction estimation

(76) Inventors: Jacob Svendenius, Lund (SE); Magnus Gafvert, Lund (SE)

Correspondence Address: ST. ONGE STEWARD JOHNSTON & REENS, LLC, 986 BEDFORD STREET, STAMFORD, CT, 06905-5619, US

(21) Appl. No.: 11/419,000

(22) Filed: May 5, 2006

Related U.S. Application Data
(60) Provisional application No. 60/678,708, filed on May 6, 2005.

(51) Int. Cl. G06F 19/00

(52) U.S. Cl. 701/70; 701/80

(57) ABSTRACT

A system for friction estimation in a vehicle is disclosed generally comprising the use of a model having a plurality of estimated parameters to establish a relationship between tire force and tire slip and determining an actual tire force and slip. The importance of each of the parameters is assessed at the actual tire force and slip, which allows the system to determine which of the parameters significantly affect the slip-force relationship, and thus, should be updated. At some times, a particular parameter is especially important for the particular slip range, while at others, more than one parameter is updated. In some cases, a forced excitation of the system is produced to facilitate accurate estimation of parameters that change rapidly.

### RELATED APPLICATIONS

This patent application claims the benefit of, under Title 35, United States Code, Section 119(e), U.S. Provisional Patent Application No. 60/678,708, filed May 6, 2005.

### FIELD OF THE INVENTION

The present invention relates to a system and method for estimating the friction between a tire and a road. More specifically, the invention relates to a system for efficiently updating the values of parameters relevant to the relation between the tire force and slip.

### BACKGROUND OF THE INVENTION

It is well known that, when developing a force between a tire and a road, the tires are exposed to a slip. When dealing with vehicle dynamics and the control of tire forces, it is commonly assumed that the force developed between the tire and the road can be expressed by a nonlinear function dependent on this slip and a set of parameters relating to actual conditions of the tire and the road.

The force generated at a particular slip depends on many factors, such as tire pressure, temperature, tire load, and the tire/road coefficient of friction, and many models exist that try to explain this behavior. This relationship may be written as:
F_{road,x}=fₓ(F_{load},slip,α,Params) (1)
F_{road,y}=f_{y}(F_{load},slip,α,Params) (2)
where F_{load} is the vertical force acting on the tire, slip is the tire slip, α is the slip angle, and Params are road and tire dependent parameters. Though such parameters are sometimes referenced separately as “road dependent” and “tire dependent” based on the relative importance of the road or tire on the particular parameter, in reality, all such parameters are dependent on the road and the tire in different proportions. The tire slip (slip) and the slip angle (α) may be defined as follows:
slip=slipₓ=(vₓ−Rₑω_{wheel})/vₓ; tan(α)=slip_{y}=v_{y}/vₓ (3)
where vₓ and v_{y} are linear velocity in the longitudinal (vₓ) and lateral (v_{y}) directions, Rₑ is the rolling radius, defined as vₓ/ω_{wheel} for a free rolling tire that does not transmit substantially any tire forces, and ω_{wheel} is the wheel rotational velocity.

For many systems in the vehicle, information about the value of the coefficient of friction between the tire and the road is valuable. Additionally, for control and stabilization purposes, though it is valuable to have a comprehensive knowledge of the relation between the slip and the tire force, it is particularly valuable to know at which slip the friction is best utilized. This slip° is defined as the optimal tire slip value, such that the resulting tire/road frictional force (F_{road}) achieves its optimum value at this slip. This optimal tire slip can be expressed as:
slip°=gₓ(F_{load},α,Params) (4)
Accordingly, the resulting optimal tire/road frictional force (F°_{road}) can therefore be expressed as:
F°_{road}=[fₓ²(F_{load},slip°,α,Params)+f_{y}²(F_{load},slip°,α,Params)]^{1/2} (5)

The nature of the tire and its interaction with the road is very complex, and a complete characterization of a tire, enabling a prediction of its behavior during any circumstances, is extremely demanding. Additionally, some particular circumstances that affect different parameters can be difficult to measure. Therefore, a perfect parameterization of the tire's behavior as it interacts with the road is very difficult.

Accordingly, as noted above, various mathematical models are employed for explaining the behavior of the tire. The road and tire dependent parameters (Params), which may be designated as Road or Tire depending on the relative importance thereof, may vary depending upon which tire model is being employed to describe the relationship between longitudinal and lateral tire forces as functions of the slips. For example, one simple but sufficiently accurate model is known to those skilled in the art as the “brush model”, which is explained in detail in the reference entitled “Tire Models For Use In Braking Applications” authored by Jacob Svendenius (Technical Report Licentiate thesis ISRN LUTFD2/TFRT—3232—SE, Lund Institute of Technology, November 2003), which is hereby incorporated by reference herein. In this model, the force-slip relationship is expressed using only three unknown parameters. The more tire-dependent parameters in this case are the tire stiffness (i.e. elasticity) in the longitudinal (C_{Tire,x}) and lateral (C_{Tire,y}) directions, and the more road-dependent parameter in this case is the tire/road friction coefficient μ_{road}. This tire model is advantageous in the respect that only a small number of parameters (three) are required.

The present invention is directed to a system for estimating the parameters in such a slip-force relationship at actual conditions. A problem that exists with respect to estimating these parameters, however, is that the parameters can change quickly, and the importance of each particular parameter changes as the amount of slip changes. Additionally, the relative importance of the parameters will also depend on the actual set of parameters. For these reasons, when the system detects a change in parameters, it is important not to rely on old data for performing estimations.

What is desired, therefore, is a system for estimating road friction that estimates the parameters at actual conditions. What is further desired is a system for estimating road friction that is not impractically complex. What is also desired is a system for estimating road friction that does not rely on old data as the parameters in the slip-force relationship change.

### SUMMARY OF THE INVENTION

Accordingly, it is an object of the present invention to provide a system for estimating road friction that employs a model to accurately characterize the behavior of the tire.

It is a further object of the present invention to provide a system for estimating road friction that accounts for changes in the importance of particular parameters as the slip changes.

It is yet another object of the present invention to provide a system for estimating road friction that accounts for changes in the relative importance of the parameters.

In order to overcome the deficiencies of the prior art and to achieve at least some of the objects and advantages listed, the invention comprises a method of friction estimation for a vehicle, the method including using a model having a plurality of estimated parameters to establish a relationship between tire force and tire slip, determining an actual tire force and an actual tire slip, assessing the importance of each of the parameters at the actual tire force and slip, determining which of the parameters to update based on the assessed importance of each of the parameters, and updating the value of each parameter that it is determined should be updated.

In another embodiment, the invention comprises a system for friction estimation for a vehicle, including a control unit operative to establish a relationship between tire force and tire slip using a model having a plurality of estimated parameters, and at least one input by which the control unit receives at least one signal representing an actual tire force and an actual tire slip, wherein the control unit is operative to assess the importance of each of the parameters at the actual tire force and slip, to determine which of the parameters to update based on the assessed importance of each of the parameters, and to update the value of each parameter that it is determined should be updated.

In some embodiments, assessing the importance of each of the parameters is at least partly based on the value of the actual tire slip, which may include, for each parameter, determining the actual tire slip falls within the slip range for that parameter. In certain embodiments, this assessment is also at least partly based on the particular set of parameters in the model.

In some embodiments, the value of each of the parameters is estimated using the actual tire force and the actual tire slip, and the system determines which individual parameter estimation or combination of parameter estimations is most reliable, which may be based on previous estimations of the parameters.

In some embodiments, updating a parameter includes determining whether an excitation of the tire force should be induced in order to reliably update the parameter and, if so, altering the tire force and/or the traction distribution between the wheels. In some embodiments, this includes outputting a signal that induces a controlled variation of brake force and/or engine torque.

### BRIEF DESCRIPTION OF THE DRAWINGS

FIG. 1 is a block diagram of a system for estimating road friction in accordance with the invention.

FIG. 2 is a block diagram illustrating detail of one embodiment of a system for controlling the application of multiple brakes of a vehicle using the estimation system of FIG. 1.

FIG. 3 is a schematic view illustrating in more detail operation of the system of FIG. 2.

FIG. 4 is a graph plotting tire force as a function of slip using the Brush Model.

### DETAILED DESCRIPTION OF THE DRAWINGS

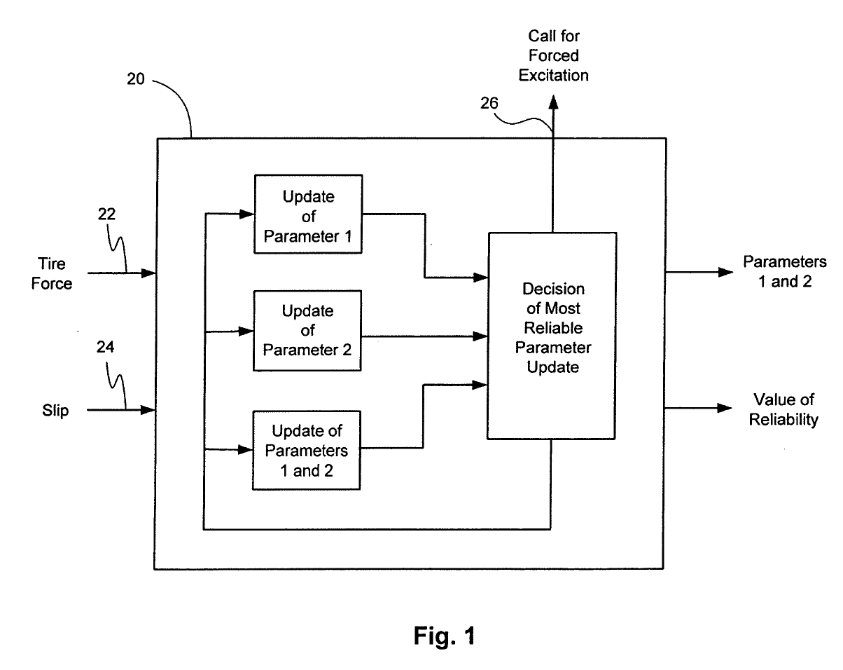

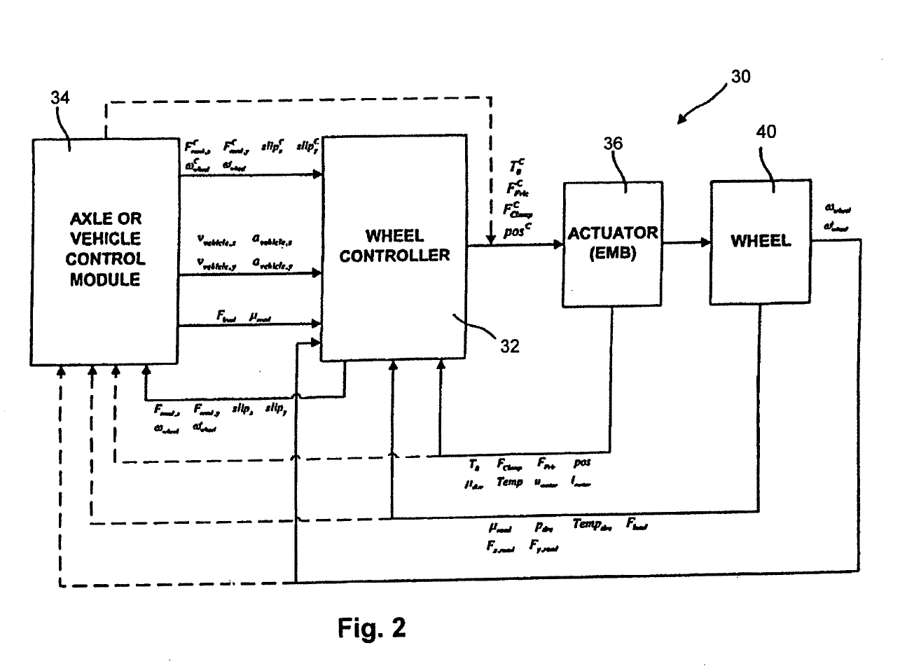

The basic components of one embodiment of a system for friction estimation in a vehicle in accordance with the invention are illustrated in FIGS. 1-3. Generally, a main goal of the estimation system described herein is to obtain the data necessary to permit the vehicle to regulate the wheel rotational velocity of each wheel such that a commanded or optimal slip is obtained, which corresponds to a commanded or maximum tire/road friction force. This objective is important, and the present invention achieves this, both for braking and for acceleration of the vehicle. This is typically achieved by controlling the application of an electronically controlled brake. A basic system 30 for this is illustrated schematically in FIG. 2, which employs a wheel brake controller 32 for regulating the wheel rotational velocity of the wheels. Such control systems are described in further detail in U.S. Patent Application Nos. 2005-0168066, 2005-0161295, 2005-0067233, the specifications of which are hereby incorporated by reference herein.

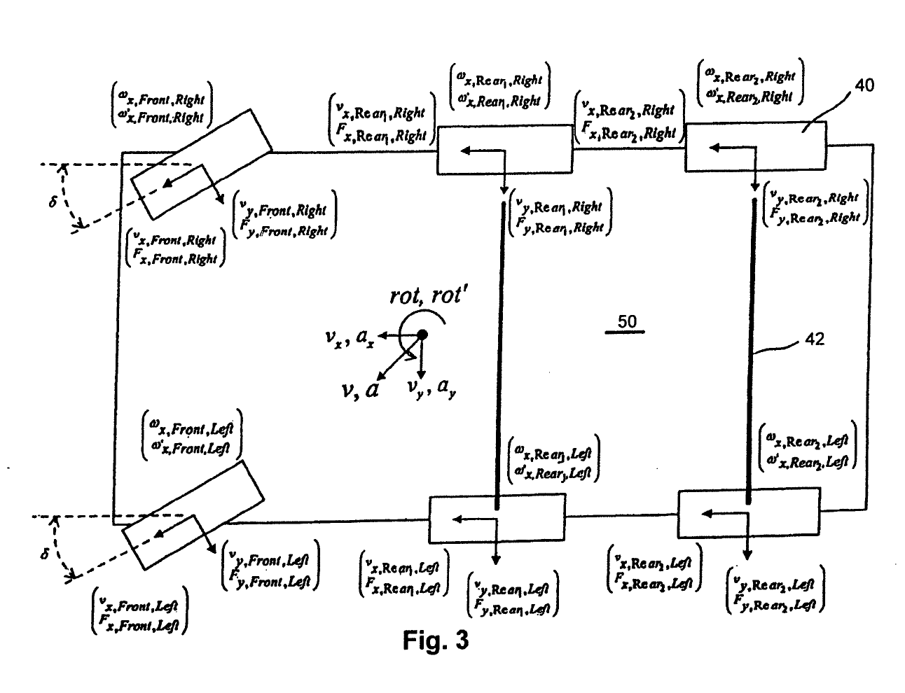

In the example shown in FIG. 2, the system 30 includes a superior vehicle control unit 34, such as, for example, an axle or vehicle control module, a wheel controller 32, an EMB brake actuator 36, and a wheel 40. Referring to FIG. 3, this system is used in a vehicle 50 having a plurality of wheels 40 connected to axels 42.

At each wheel 40, the wheel rotational velocity ω_{wheel} and optionally also the wheel rotational acceleration/retardation ω′_{wheel}, are measured and signals are generated based thereon. The vehicle speed (v) in the longitudinal (vₓ) and lateral (v_{y}) directions of the vehicle 50 are estimated by using the wheel rotational velocity ω_{wheel} signals from a number of wheels 40. Additionally, vehicle acceleration (α) in the longitudinal (αₓ) and lateral (α_{y}) directions and/or the rate (rot) and/or acceleration (rot′) of vehicle rotation may be used for this purpose. Also, sensor signals for tire/road frictional forces in the longitudinal F_{road,x} and lateral F_{road,y} directions of the tire 40 may be used for this purpose. A sensor signal for steering angle δ may also be used. Another option is to directly measure the vehicle speeds (v, vₓ, v_{y}), although this may be more cumbersome. The vehicle speed estimation functionality may either be performed in the wheel controller unit 32 or in a superior vehicle control unit 34.

The linear velocity in the longitudinal and lateral directions of each individual wheel 40 are estimated by using the estimated or measured vehicle speeds (v, vₓ, v_{y}) described above. Such wheel linear velocities are shown in FIG. 3 for each wheel 40 with reference labels appropriate for each wheel 40. For example, for the second rear right tire, the longitudinal linear wheel velocity is referenced by the designation v_{x,Rear2, Right,} while the lateral linear wheel velocity thereof is referenced by the designation v_{y,Rear2, Right}. A sensor signal for steering angle δ may also be used. Additionally, a sensor signal for rate of vehicle rotation (rot) in combination with dimensions of the vehicle 50 may be used. The linear velocity in longitudinal and lateral direction of each individual wheel 40 may either be done in the wheel controller unit 32 or the superior vehicle control unit 34.

The tire/road wheel slip in the longitudinal slipₓ and lateral slip_{y} directions of each individual wheel 40 of the vehicle 50 are calculated by using the sensor signals for rotational velocity ω_{wheel} and the estimated linear velocity in the longitudinal (vₓ) and lateral (v_{y}) direction of each individual wheel 40. The tire/road wheel slip (slipₓ, slip_{y}) could also be measured directly. The tire/road wheel slip estimation functionality may either be done in the wheel controller unit 32 or the superior vehicle control unit 34.

As previously explained, the static and dynamic properties of the tire/road interactions are typically summarized by a mathematical model representing the relationship between tire force and slip. The parameters of the tire/road model may be estimated online based on sensor signals, and this estimation may be performed either in the wheel controller unit 32 or the superior vehicle control unit 34. As a result, many different aspects of properties of the tire and its interactions with the road can be estimated using this slip-force relation, as discussed below.

For example, the estimated tire/road wheel slip (slipₓ, slip_{y}) together with a signal indicative of the brake torque T_{B} of that wheel, provided by the EMB brake actuator 36, together with load force F_{load} estimates of that wheel, may be used for this parameter estimation. Also, the traction torque signal provided by the engine model, as well as the brake torque from the EMB, may be employed. Also, sensor signals indicative of tire pressure pₜᵢᵣₑ, tire temperature Tₜᵢᵣₑ, tire/road friction coefficient μ_{road}, and/or tire/road friction force F_{Fric}, may by used for this parameter estimation.

The tire/road friction coefficient μ_{road} at each individual wheel 40 may be estimated by using the estimated slip (slipₓ, slip_{y}) described above together with a signal indicative of the brake torque of that wheel T_{B}, provided by the EMB brake actuator 36, together with estimates of the load force F_{load} at that wheel, together with the dimensions of the wheel 40 itself. Also, the traction torque signal provided by the engine model, as well as the brake torque from the EMB, may be employed. The wheel rotational velocity ω_{wheel} and/or acceleration/retardation ω′_{wheel} may also be used. The tire/road friction coefficient μ_{road} could also be measured directly. An alternative is to estimate a tire/road frictional coefficient μ_{road} indicative of the entire vehicle 50. Then the sensor signal for vehicle longitudinal (αₓ) and lateral (α_{y}) acceleration and for acceleration of vehicle rotation (rot′) may be used together with the wheel slips (slipₓ, slip_{y}) of each individual wheel 40 and the dimensions of the vehicle 50. A signal indicative of the brake torque T_{B} of each individual wheel 50, provided by the EMB brake actuator 36, may also be useful.

The tire/road friction force in the longitudinal F_{road,x} and lateral F_{road,y} directions of each wheel 40 are estimated by the use of the tire/road model together with the wheel slips (slipₓ, slip_{y}) and load force F_{load} and the estimated tire/road friction coefficient μ_{road} of each individual wheel 40. An alternative is to estimate the tire/road friction force in the longitudinal F_{road,x} and lateral F_{road,y} directions of an individual wheel 40 by using a signal indicative of the brake torque T_{B}, provided by the EMB brake actuator 36, together with the sensor signal for wheel rotational acceleration/retardation ω′_{wheel}. Also, the traction torque signal provided by the engine model, as well as the brake torque from the EMB, may be employed. The dimensions (i.e., the radius) of the wheel 40 itself may also be used in determining the tire/road friction force.

The various sensor signals may either be primarily provided directly to the wheel control unit 32 or, as indicated in FIG. 2 by dashed lines, directly to the superior vehicle control unit 34, or directly to both of them. The various sensor signals could then be passed over to other wheel control unit(s) 32 or other superior vehicle control unit(s) 34 (such as, for example, if a superior vehicle control unit 34 is used on each vehicle axle 42, using a communication network. Through this communication network, the other wheel control unit(s) 32 and the superior vehicle control module(s) 34 can share information generated in the individual wheel control units 32).

As noted, the purpose of the wheel controller 32 is to control the braking of an individual wheel 40. There are a number of control strategies that may be employed for this. An advantageous method is to regulate the wheel rotational velocity ω_{wheel}. The ideal goal of the wheel brake controller 32 is then to regulate the wheel rotational velocity ω_{wheel} such that the commanded or optimal wheel slip (slip^{C}ₓ, slip^{C}_{y}) is obtained. It should be noted that the commanded wheel slip (slip^{C}ₓ) corresponds to the optimal slip (slip°) described in Equation 4. The slip (slip^{C}ₓ, slip^{C}_{y}) corresponds then to a commanded or maximum tire/road friction force (F^{C}_{road,x}, F^{C}_{road,y}). Another alternative is to regulate braking based upon on measured wheel slip (slipₓ, slip_{y}) directly. The slip (slip^{C}ₓ, slip^{C}_{y}) could then be controlled in such a way that corresponding commanded or maximum tire/road frictional forces (F^{C}_{road,x}, F^{C}_{road,y}) are obtained. Yet another alternative is to control braking based on measured tire/road frictional force (F_{road,x}, F_{road,y}) directly. The tire/road frictional force (F^{C}_{road,x}, F^{C}_{road,y}) is then controlled in such a way that commanded or maximum tire/road frictional forces (F^{C}_{road,x}, F^{C}_{road,y}) are obtained. In all cases described above, the commanded wheel rotational speed/slip/tire-road-force may be provided from the superior vehicle control module 34.

Additionally, it should be noted that other wheel control schemes are possible. The objectives of the wheel control could be limited to regulate the wheel slip (slipₓ, slip_{y}) to a value provided by a superior vehicle control unit 34. Yet another alternative is to limit the objectives to wheel rotational velocity ω_{wheel} control. The wheel rotational velocity ω_{wheel} is then controlled to a commanded wheel rotational velocity ω^{C}_{wheel} control signal, provided by a superior vehicle control unit 34. Control can similarly be achieved based upon a commanded wheel rotational acceleration ω^{,C}_{wheel}. In other circumstances, the EMB brake actuator 36 may be controlled without direct use of feedback. It should be understood the wheel brake control could comprise the functionality known as ABS in known systems.

Returning to FIG. 1, a control unit 20, which may, for example, be located in the wheel control unit 32 or superior vehicle control unit 34, receives signals 22, 24 representing the tire force and tire slip at actual conditions. The signals 22, 24 may represent a direct measurement, or may reflect the value(s) of other parameters from which the tire force and slip are calculated. The control unit 20 determines the value of the actual tire force and actual slip, which it uses with the mathematical model to estimate the parameters.

Generally, at least two parameters are required to attain sufficient accuracy in accordance with the present invention. As explained above, for many systems in the vehicle, information about the coefficient of friction between the tire and the road is very valuable. Accordingly, one particularly useful model is the tire brush model, which represents a relationship between the tire force and the tire slip that relies only on tire stiffness (i.e. elasticity) in the longitudinal (C_{Tire,x}) and lateral (C_{Tire,y}) directions, and the tire/road friction coefficient μ_{road}.

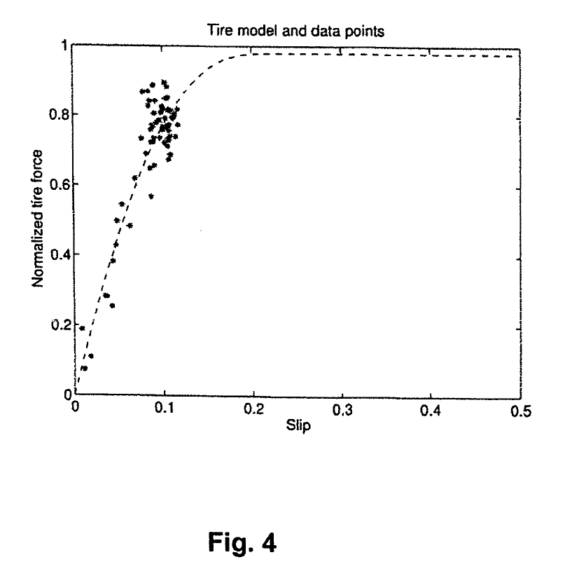

The importance of each of the parameters changes throughout the slip range. In some regions, only one parameter has a significant effect on the slip-force relationship, while in other regions, multiple parameters are important. An example employing the brush model is shown in FIG. 4, which is a plot of the normalized tire force versus tire slip. The tire stiffness is important at small slips, while the coefficient of friction is significant at high slips. In between, both parameters are important.

Generally, if the actions of the operator result in sufficient excitation of the system, more than one parameter can be estimated. When multiple parameters are updated simultaneously, a set of data points is required. For example, in the brush model shown in FIG. 4, while the tire force is increased during the brake application phase, there is sufficient information available for the estimation of both parameters. However, trying to estimate both parameters using all plotted dots would provide an unreliable result since the characteristics of signal noise when the brake force is settled will dominate due to the large amount of data points. Therefore, the control unit 20 must decide when it is appropriate to only perform single parameter updates.

Because parameters can sometimes change rapidly, it is important not to rely on old data when the estimation device detects a change of parameters. Therefore, it is often useful to have a certain amount of excitation of the system so that reliable data points are available in a sufficiently large area of the force-slip domain. The size of the area depends on the signal noise and how many parameters (and which particular parameters) have to be estimated. Accordingly, the driver or stabilization system changes the tire force a certain amount, forcing an excitation of the tire force via controlled variation of brake force and/or engine torque. While, as further described below, forced excitation in response to a request for such from the system may be advantageously employed, the natural excitation resulting from the actions of the operator is typically used for the estimation.

Examining the tire force and slip values, the control unit 20 decides which of the parameters can be reliably updated. The update of a parameter is based on a recursive algorithm, such as recursive least squares, Kalman filtering, or the MIT rule, which minimizes the error between the model and the measurements. The control unit 20 then also decides whether a forced excitation is necessary in order to obtain a more reliable update. The decision algorithm of the control unit 20 repeatedly makes these decisions, enabling it to determine when to switch from multiple-parameter to single-parameter updates. If a change of a parameter is detected, the control unit may request a forced excitation, as described above, to check whether another parameter has changed. It should also be noted, however, that while the use of such forced excitation may be advantageous, the system need only rely on the natural excitation from the actions of the operator in order to operate effectively.

It should be understood that the foregoing is illustrative and not limiting, and that obvious modifications may be made by those skilled in the art without departing from the spirit of the invention. Accordingly, reference should be made primarily to the accompanying claims, rather than the foregoing specification, to determine the scope of the invention.

What is claimed is:

1. A method of friction estimation for a vehicle, the method comprising:
using a model having a plurality of estimated parameters to establish a relationship between tire force and tire slip;
determining an actual tire force and an actual tire slip;
assessing the importance of each of the parameters at the actual tire force and slip;
determining which of the parameters to update based on the assessed importance of each of the parameters; and
updating the value of each parameter that it is determined should be updated.

2. The method of claim 1, wherein the step of updating comprises updating more than one of the parameters when there is sufficient excitation of the tire force to estimate more than one parameter.

3. The method of claim 1, wherein the step of assessing the importance of each of the parameters is at least partly based on the value of the actual tire slip.

4. The method of claim 3, further comprising the step of determining a slip range for each parameter, wherein the step of assessing the importance of each of the parameters comprises determining, for each parameter, whether the actual tire slip falls within the slip range for that parameter.

5. The method of claim 3, wherein the step of determining which of the parameters to update is at least partly based on the particular set of parameters in the model.

6. The method of claim 3, wherein the steps of assessing the importance of each parameter and determining which of the parameters to update comprise:
estimating the value of each of the parameters using the actual tire force and the actual tire slip; and
determining which individual parameter estimation or combination of parameter estimations is most reliable.

7. The method of claim 6, wherein the determination of the reliability of individual and combination parameter estimations is based on previous estimations of the parameters.

8. The method of claim 1, wherein the step of updating the value of each parameter that it is determined should be updated comprises:
determining whether an excitation of the tire force should be requested to update the parameter; and
altering the tire force in response to a determination that an excitation of the system should be induced.

9. The method of claim 8, wherein the step of determining whether an excitation of the tire force should be requested to update the parameter is based on the detection of a change in at least one other parameter.

10. The method of claim 8, wherein the step of altering the tire force comprises executing a controlled variation of at least one of a brake force and an engine torque.

11. The method of claim 1, wherein the step of determining the actual tire force and actual tire slip includes receiving a signal representing the value of at least one parameter from which at least one of the actual tire force and the actual tire slip is calculated.

12. The method of claim 1, wherein the plurality of parameters includes at least one substantially road-dependent parameter and at least one substantially tire-dependent parameter.

13. The method of claim 1, wherein one of the parameters is the coefficient of friction.

14. The method of claim 13, further comprising using the estimated parameters to calculate an optimal slip.

15. The method of claim 1, wherein the model is the brush tire model.

16. The method of claim 1, wherein, the step of updating the value of each parameter that it is determined should be updated is based on a recursive algorithm.

17. The method of claim 16, wherein the recursive algorithm comprises Recursive Least Squares, Kalman filtering, or the MIT rule.

18. A system for friction estimation for a vehicle, comprising:
a control unit operative to establish a relationship between tire force and tire slip using a model having a plurality of estimated parameters; and
at least one input by which said control unit receives at least one signal representing an actual tire force and an actual tire slip;
wherein said control unit is operative to assess the importance of each of the parameters at the actual tire force and slip, to determine which of the parameters to update based on the assessed importance of each of the parameters, and to update the value of each parameter that it is determined should be updated.

19. The system of claim 18, wherein said control unit updates more than one of the parameters when there is sufficient excitation of the tire force to estimate more than one parameter.

20. The system of claim 18, wherein said control unit assesses the importance of each of the parameters using the value of the actual tire slip.

21. The system of claim 20, wherein said control unit is operative to determine a slip range for each parameter, wherein the control unit assesses the importance of each of the parameters by determining, for each of the parameters, whether the actual tire slip falls within the slip range for that parameter.

22. The system of claim 20, wherein said control unit determines which of the parameters to update at least partially based on the other parameters in said model.

23. The system of claim 20, wherein said control unit estimates the value of each of the parameters using the actual tire force and slip, and determines which individual parameter estimation or combination of parameter estimations is most reliable.

24. The system of claim 20, wherein the determination of the reliability of individual and combination parameter estimations is based on previous estimations of the parameters.

25. The system of claim 18, wherein said control unit is operative to determine whether an excitation of the tire force should be requested to update a parameter, further comprising an output for communicating an excitation signal to alter the tire force.

26. The system of claim 25, wherein the control unit determines whether an excitation of the tire force should be requested to update the parameter based on the detection of a change in at least one other parameter.

27. The system of claim 25, wherein the excitation signal controls a variation of at least one of a brake force and an engine torque.

28. The system of claim 18, further comprising at least one sensor that measures at least one parameter from which at least one of the actual tire force and tire slip are calculated and communicates said signal to said control unit.

29. The system of claim 18, wherein said at least one sensor comprises a sensor that directly measures the tire slip.

30. The system of claim 18, wherein the plurality of parameters includes at least one substantially road-dependent parameter and at least one substantially tire-dependent parameter.

31. The system of claim 18, wherein one of said parameters is the coefficient of friction.

32. The system of claim 31, wherein said control unit is operative to use the parameters to calculate an optimal slip.

33. The system of claim 18, wherein said model is the tire brush model.

34. The system of claim 18, wherein said control includes a recursive algorithm for updating the parameters.

35. The system of claim 34, wherein said recursive algorithm comprises Recursive Least Squares, Kalman filtering, or the MIT rule.
